(19) United States
(12) Patent Application Publication
(10) Pub. No.: US 2010/0009040 A1
(43) Pub. Date: Jan. 14, 2010

(54) BREAKFAST CEREAL PUZZLE PIECES AND METHOD OF PREPARATION

(76) Inventors: Susan L. Kamper, Waconia, MN (US); Timothy O. Hansen, Coon Rapids, MN (US)

Correspondence Address: GENERAL MILLS, INC., P.O. BOX 1113, MINNEAPOLIS, MN, 55440, US

(21) Appl. No.: 12/438,771

(22) PCT Filed: Oct. 13, 2006
(86) PCT No.: PCT/US06/40196

§ 371 Date: Feb. 25, 2009

(51) Int. Cl. A23P 1/00; A23L 1/10; A23L 1/00

(52) U.S. Cl. 426/87; 426/104; 426/383

(57) ABSTRACT

The present invention resides in food products and in their methods of preparation. More particularly, the present invention provides food products, especially shelf stable to ready-to-eat (“R-T-E”) or breakfast cereals mixes in the form of loose blends of individual pieces with the pieces including shaped and sized pieces having a portion of an image on a major surface that collectively, can be used to form image puzzles for enhanced play value such as for children. The present methods of preparation involve preparing pieces having a portion of an image on a major surface and blending those shaped pieces to provide loose blends of individual pieces whereby a food product blend can be provided having enhanced play value.

### BACKGROUND OF THE INVENTION

The present invention relates to food products and to their methods of preparation. More particularly, the present invention relates to ready-to-eat (“R-T-E”) or breakfast cereals mixes in the form of loose blends of individual pieces with the pieces including shaped and sized pieces having a portion of an image on a major surface that collectively, can be used to form image puzzles for enhanced play value such as for children. The present methods of preparation involve preparing pieces having a portion of an image on a major surface and blending those shaped pieces to provide loose blends of individual pieces whereby a food product blend can be provided having enhanced play value.

A wide variety of food products are prepared from cooked cereal doughs especially ready-to-eat (“R-T-E”) or breakfast cereals, as well as a variety of snack products. Generally in the preparation of the cooked cereal dough, cereal or farinaceous ingredients such as various cereal flours are first admixed with other dry ingredients such as salt, minerals, starch, sugars, to form a dry blend of ingredients and then is further blended with various liquid ingredients, including moisture and heated to gelatinize or cook the starch fraction of the cereal ingredients and other starchy materials. The gelatinized or cooked mass is then worked to form homogenous or well blended cooked cereal dough. A wide variety of blending cooking, working apparatus and techniques are well known. Also, known cooked cereal dough formulation and preparation methods include formulation and processing condition variations such as those intended to increase or minimize shear depending upon desired end product attributes and skilled artisan's beliefs of such variations and their interactions on end product attributes.

A wide variety of R-T-E cereals are commercially available typically as dry or shelf stable packaged food products. Such products are generally in articles comprising a sealed bag or pouch of a quantity of R-T-E cereal pieces usually but not always disposed within a protective outer container such as a cardboard carton having front and rear major face panels.

Breakfast cereal market categories importantly include children's R-T-E cereals. Such children's R-T-E cereals can, for example, include shapes, colors, flavors, added ingredients, or other features that make these cereals products particularly appealing to children. Within this market category, products can be developed that are particularly suitable for children of particular age ranges.

The R-T-E cereal products, like other packaged consumer food products, can be provided with features to the product, and/or the package that increase the appeal or play value to children. For example, often premiums such as baseball cards or small toys are added to the packaged food article that is promoted on the or with product packaging. In another example, the packaged food article can have all or a portion of the product packaging, that has increased play value such as a puzzle or game printed on the rear major face panel.

Often the appeal of the product is enhanced by a licensed equity promotion such as a cartoon or movie or character. The product can have one or more features as a tie-in to the equity used as a promotion. For example, the pieces can have shapes or colors that are associated with the equity. For a cartoon show having a variety of characters, the cereal can have one or more pieces shaped as the characters, their companion animals or something that is associated with the character such as an item used by the character.

However, the appeal of such novelty features to children's R-T-E cereal products is short lived. Consequently, the industry is constantly in search of new techniques for adding novelty and appeal to children's food products. In particular, it would be especially desirable to develop a feature or technique that could be easily, economically, and rapidly modified to apply change or continuing novelty to a product whose principle characteristics remain relatively constant.

Also, it would be desirable to increase the appeal of a children's food product by increasing its play value. While playing with children's food is discouraged in some cultures, increasing the play value of foods especially those either specifically targeted two children or stylized as “all-family” (and thus including children) can be an important feature or benefit for such foods.

In one example, a snack mix for children has been developed that includes not only well known cereal shapes (such as those marketed under the Chex® cereals) but importantly adds play value by adding in specially shaped pieces such as crackers and pretzels to provide a blend having enhanced play value. (See, for example, US 2006/0193963 “Snack Mix of Enhance Play Value” published Aug. 31, 2006 by Terry Harrington). Thus, the snack mix comprises a blend of common dried cooked cereal pieces along with new shapes of crackers and/or pretzels to provide enhance play value.

In another example, a food product for providing play value to consumers is provided. The food product comprises a plurality of individual, edible food pieces having various complementary shapes such that the food pieces can be arranged as a puzzle to form an increasingly complex and recognizable structure. Each of the plurality of food pieces are an aerated confection comprising a sweetener and a structuring agent. The food product may be incorporated in a finished ready-to-eat (R-T-E) cereal. (See, “Aerated Confection Puzzle” published on Sep. 1, 2005 as US 2005/0191407 by Okos et al.; See also, US 2005/0191405 “Starch-Molded Fruit Snack Puzzle” by Okos et al published on Sep. 1, 2005).

The present invention is an improvement in known methods of providing food products of enhanced play value. In the present invention, a method is provided for forming a blend of individual pieces each of which has at least one portion of a larger image printed onto a major surface. The multiple pieces can be selected to reassemble or form that image (or at least a portion thereof). In this invention, known cereal forms, formulations and production techniques can be easily modified to provide the novel pieces. Moreover, the images can be easily modified or changed to provide on-going methods of providing desirable novelty and play-value especially in regards to licensed character equities.

The present invention includes forming an image onto a sheet of cooked cereal dough and then severing those individual pieces each of which has at least a portion of that image on a major surface. Thereafter, the pieces are then formed into finished shelf stable pieces in the form of a blend wherein pieces can be selected to at least partially reassemble the image in the manner of a jig saw puzzle. Such finished food blends provided enhanced visual appeal by virtue of the image fragments or portions and have enhanced play value.

### BRIEF SUMMARY OF THE INVENTION

In its product aspect, the present invention resides in food products of enhanced play value. The food products comprise a quantity of individual food pieces form having at least one major surface area disposed upon which is a portion of an image that collectively, can be used to form image puzzles.

In its article aspect, the present invention resides in a packaged consumer food article. The article includes a quantity of individual food pieces form having at least one major surface area disposed upon which is a portion of an image that collectively, can be used to form image puzzles. The pieces are disposed within, and the articles further include, a food package in the form of a sealed food container.

A method for preparing a food product having enhanced play value, comprising the steps of: providing cooked cereal dough in the form of a continuous sheet having a major surface; forming the sheet into individual pieces at least some of which have at least a image fragment; and forming the pieces into a quantity of finished food products pieces each having at least one major surface and each having at least a portion of an image on the major surface that collectively can be used to at least partially reassemble the image thereby forming image puzzles

### BRIEF DESCRIPTION OF THE DRAWINGS

FIG. 1 is a plan view photograph of one embodiment of the finished cereal products of the present invention showing a partial image portion on the major surface of the cereal piece.

FIG. 2 is a plan view photograph of one embodiment of the finished cereal products of the present invention showing a different partial image portion on the major surface of the cereal piece.

FIG. 3 is a schematic process flow diagram of one embodiment of the methods of preparation of the present invention.

### DETAILED DESCRIPTION OF THE INVENTION

The present invention resides in food products and in their methods of preparation. More particularly, the present invention provides food products, especially shelf stable to ready-to-eat (“R-T-E”) or breakfast cereals mixes in the form of loose blends of individual pieces with the pieces including shaped and sized pieces having a portion of an image on a major surface that collectively, can be used to form image puzzles for enhanced play value such as for children. The present methods of preparation involve preparing pieces having a portion of an image on a major surface and blending those shaped pieces to provide loose blends of individual pieces whereby a food product blend can be provided having enhanced play value. Each of these components as well as product properties, preparation and use are described in detail below.

Throughout the specification and claims, percentages are by weight and temperatures in degrees Centigrade unless otherwise indicated. Each of the referenced patents is incorporated herein by reference.

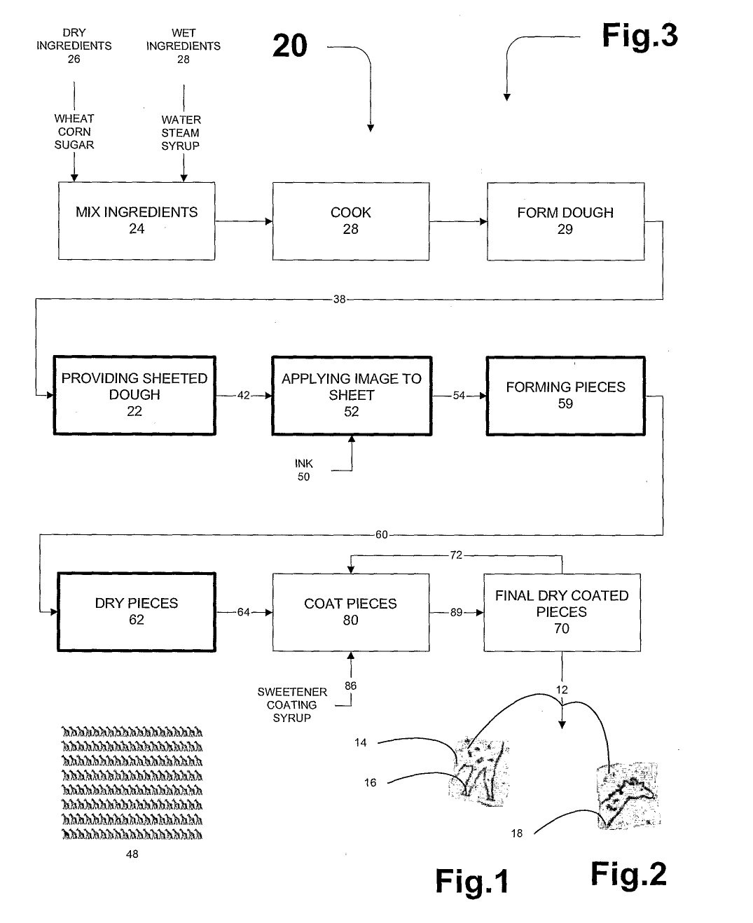

Referring now to FIGS. 1 and 2 the food product is in the form of a quantity or blend of edible individual food pieces 12 each of which has at least a first major surface 14 having at least a portion 16 of an image 18 thereon. The individual pieces can be used to form image puzzles, or parts thereof, for enhanced play value such as for children to form an edible puzzle.

In the preferred form, each of the plurality of food pieces 12 is an R-T-E cereal piece. However, while in the present description particular attention is paid to R-T-E cereal products, the skilled artisan will appreciate that the invention has applicability to a wide variety of food applications. For example, a wide variety of snack products are prepared from cooked cereal dough in the form of dried shelf stable products. In particular, fried snack pieces are fabricated from thin sheets of cooked cereal dough such as corn based formulations for corn chips or potato doughs for the preparation of fabricated potato chips. Of course, while the doughs can be sheeted or planar when the image is applied there upon, it will be appreciated that the finished product can be planar as in the preferred form or can be curled such as resulting from any finish drying, e.g., deep fat frying, step.

Also, while particular attention is paid to the provision of finished products that are dried to low moisture contents to provide shelf stable products, the present invention is also directed towards those intermediate products of higher moisture content useful in the production of such finished goods. Such intermediate products refer to not only the wet or pieces (e.g., shaped and sized pieces 60 as described below) but also any partially dried pieces such as shelf stable pellets 66 (also described below) that can be finished dried in a later step. Also, the dough pieces having the partial image portion can be fabricated from dough that can be raw or partially cooked in addition to the preferred cooked cereal dough.

In preferred form, the R-T-E cereal piece can be generally prepared from cooked cereal doughs using known formulations and cooking and preparation techniques. In a preferred form, the R-T-E cereal is in the form of a square planar pieces having at least a pair of opposed major surfaces including the top or image bearing major surface 16. For example, the pieces can have a length and width each ranging from about 1-3 cm, preferably about 1.5-2 mm, defining minor peripheral edges or surfaces and having a thickness of about 1-4 mm, preferably about 2-3 mm. Snack pieces can be larger sized, e.g., 2-5 cm in linear dimension. While a square form is preferred, other peripheral configurations can be used including those forming regular geometric shapes, e.g. rectangles or other parallelograms. In variations, the peripheral can be a tessellated shape such as an equilateral triangle, hexagon, octagon or regular geometric shape. In still other variations, the periphery can be in the shape of an object or figurine. In still other variations, less preferred, the cereal piece can include a jig-saw puzzle outline feature(s) such as a socket and/or projection for mating with a socket.

Conveniently, conventional cereal products can be used as a cereal base to which the image portions are applied. In a preferred execution, the cereal base is that cereal presently used for those non-puzzle image bearing R-T-E cereals as Cinnamon Toast Crunch or Golden Grahams (marketed in the USA by General Mills, Inc.).

In useful but less preferred variations, the pieces can be in the form of flakes such as are fabricated from corn and/or wheat. Such cereal forms are less preferred in part to their fragility (relative to the preferred cereal base forms herein).

As can be seen from the cereal pieces depicted in FIGS. 1 and 2, the piece 12 importantly includes an image portion or fragment on at least one major surface such as the portion of a giraffe outline depicted. In still other variations (not shown), the piece 12 can include an entire image including, for example, an alphanumeric symbol, especially letters or mixtures of numeral and letter with each piece having a complete letter or number. The image can be of a simple single color line image or more complex such as a multi-colored print image. As described in more detail below, the present invention can be in the form of a packaged consumer food article including a food package such as box or carton having a game board (whether as an added premium or printed upon either the exterior or interior carton panel). The pieces having the alphanumeric images thereof can be used as game pieces in connection with the game board such as word games such as Scrabble. In other variations, the picture or image can be of any other symbol or depiction that provides play value. It is also seen that the image fragment or portion is randomly located on the major surface. In still other variations, the opposed major surface can additionally include an image that can be the same or different from the first image on the opposed major surface.

In the provision of an R-T-E cereal, the pieces general, each of the food pieces 12 has a bulk density in the range of from 0.1-1.0 grams per cubic centimeter (g/cc.), more preferably from 0.25-0.4 g/cc. The food pieces 12 are preferably dried to a moisture level of less than 5%, typically about 1-4%, such as to provide a water activity value ranging from about 0.1-0.3 to provide extended shelf stability at room temperature distribution and storage. In view of the low water content, the food pieces 12 in this embodiment typically have a firm texture and are resistant to absorbing liquids, e.g., milk. The food pieces 12 are preferably bite-sized such that they can be easily manipulated and consumed by the consumer.

In other variations, the food pieces 12 can be intermediate products used in the commercial manufacture of finished products. For example, the intermediate products can be in the form of wet cooked cereal doughs having moisture contents ranging from about from 15-30%. In still other variations, the food pieces are dried from the 15-30% moisture of the wet pieces to shelf stable but less than finish moisture contents to form intermediate cereal or snack pellets. Such pellets are typically dried to moisture contents ranging from about 7-16%, preferably about 9-14%. These pellets can be shipped in bulk for finish drying or processing to finish moisture contents of less than about 5%. Such pellets can be usefully shipped (e.g., exported) in bulk for finish preparation physically closer to the end market.

As indicated above, the food pieces 12 find particular suitability for use as the base (i.e., being the highest percentage component of a blend) or at least the principle component of, especially sugar coated R-T-E cereals. In an alternate embodiment wherein the pieces are included as an appealing added component of, or in, a cereals blend, a finished R-T-E cereal can comprise from about 65-99% of a conventional dried cereal. (such as flakes, shreds, biscuits, or puffs formed from a cooked cereal grain or dough of oats, wheat, corn, barley, rice or mixtures thereof) and from about 1-35% of the food pieces 12, more preferably from about 15-25% of the food pieces 12.

In this manner, consumers, e.g., children, especially younger children, e.g., ages 6-9, can discover the food pieces 12 in the R-T-E cereal that are necessary to form the image. This adds substantial play value to the R-T-E cereal. In still other embodiments, the food pieces 12 can be provided in separate packaging, or can be used as toppings for desserts such as ice cream or yogurt. The food pieces 12 could also be incorporated in various other food items.

In still other preferred variations, the finished cereal blend can additionally include a wide variety of fabricated aerated, form-stable confections especially marshmallow bits, which are well-known for use in ready-to-eat cereals. Additionally comprising particulates such as nut clusters; dried fruit pieces; other cereals and mixtures thereof.

In preferred form, the cereal pieces 12 are desirably light in color, e.g., off-white to tan or even light brown. To apply the image, a contrasting color or color hue, e.g., a darker edible ink is applied to form the image. In less preferred variations, the cereal piece is of a dark color, e.g., a dark brown for chocolate flavored children's cereal, while the image is provided by an edible white colored ink. For multi-colored cereal base pieces, it is desired only that the base color be such that the image fragment is easily discernable. Blends of differently colored pieces are also contemplated. For example, children find primary colors to be attractive such as yellow, white, blue, and red. A blend can comprise pieces then some of which are red, some white, some yellow. Often the colors are tied in to flavors, e.g., various berry or citrus flavors.

The term color includes any color (including black and white), hue, shade, or variation thereof which may be provided by the addition of any natural or synthetic coloring agents, or which is naturally provided by mixing the ingredients of the food pieces 12 together.

The food pieces 12 can have any combination of flavors. Each food piece 12 can have a different flavor than other food pieces 12, each food piece 12 can have multiple flavors, or each of the food pieces 12 can have the same flavor. The food pieces 12 preferably have a uniform texture and composition throughout. In other embodiments, the colored portions can have dissimilar compositions.

In one preferred embodiment, the image and thus the pieces 12 herein are selected to provide a tie in to a theme or licensed product equity. In the present illustration, an image or partial image of a giraffe is provided that can be part of an animals theme. In another variation, the image, e.g., giraffe can be a tie-in to a movie, cartoon, book, toy, or TV program that has an animal or jungle theme.

In another embodiment, the present invention resides in food articles such as a game kit. In addition to the present food product pieces 12, the game kit can additionally include a supplemental play component such as a game board. In another embodiment, the game kit can include a set of instructions whether or not the kit includes a game board. In one embodiment, the game board can be a checkerboard design like game board. The checkerboard design like game board has a generally square shape and a playing facade 30, in which the playing facade comprising a plurality of alternately spaced dark and light squares.

In still other variations, the game kit can comprise one or more supplemental game items such as a bucket; a pail; question tabs; bonus tabs; reference cards; a first set of play pieces; a second set of play pieces; a collection of first award tokens; a collection of second award tokens; and mixtures thereof.

In one embodiment, the present invention resides in consumer food packaged food articles comprising a quantity of the food pieces disposed within a food package. In preferred form, the package includes a sealed bag and can include an exterior carton within which the bagged cereal is disposed. The consumer food packaged food article can additionally include the game kit. In certain variations, the carton can have opposed major front and rear face panels and the game board printed on a portion of either the exterior or interior of one of the major face panels. In still other variations, the carton can include a licensed equity for a tie-in promotion of the cereal that includes an association with the image to the licensed equity. For example, the equity can be a cartoon or movie character or famous athlete or team and the image can be of related character. In this way, and especially if the packaged food article includes additional game kit components, the play value of the food pieces can be significantly enhanced. In still other variations, the article can include one or more premium items inserted into the carton such as a game board and/or additional game kit components, (e.g., additional game pieces).

For snack product offerings, the food products can additionally include one or more supplemental components such as cracker pieces, pretzel pieces, peanuts, fruit pieces, dried meat pieces, and mixtures thereof.

Now that the features of the present food products have been describe in detail, attention is now paid to methods for the preparation and fabrication of such novel food products.

Referring now to FIG. 3, there is seen a schematic flow diagram of the preferred embodiment of method of preparation generally designated by reference numeral 20. In the preferred embodiment, the present methods 20 can comprise the steps of providing cooked cereal dough in the form of a continuous sheet having a major surface; applying an image to that major surface, forming the sheet into individual pieces at least some of which have at least a image fragment; and forming the pieces into finished food products pieces that collectively can be used to at least partially reassemble the image thereby forming image puzzles.

The methods can thus include a first step 22 of providing cooked cereal dough in the form of a continuous sheet having a major surface. As is well known, a cooked cereal dough can be prepared, and step 22 comprise the sub-steps of, by a first sub-step 24 of mixing or blending various dry cereal ingredients 26, especially wheat, corn and sugar, together with wet ingredients 28 such as water or steam 28; and second sub-step of cooking 28 to gelatinize the starchy components and to develop a cooked flavor to form a cooked cereal component; and working or forming 29 the cooked cereal component into as a cooked cereal dough rope or extrudate 38.

The cooking and mechanical work can occur simultaneously or sequentially such as in a cooker extruder. The cereal dough cooking step can be practiced using a batch, atmospheric cooker and a low pressure extruder cooker especially those equipped with a conditioner precooker, or a twin screw extruder. The cereal is cooked with steam and sufficient amounts of added water for times and at temperatures sufficient to gelatinize the cereal starch and to develop desired levels of cooked cereal flavor.

An essential component of the present cereal compositions is a starchy cereal(s). The starchy cereal component can comprise any conventionally employed starchy cereal or, synonymously, farinaceous material, for use in a ready-to-eat cereal. Exemplary suitable starchy cereals include cereal grains, cut grains, grits or flours from wheat, rice, corn, oats, barley, rye, triticale or other cereal grains and mixtures thereof. The flours can be whole flours or flour fractions such as with the germ fraction or husk fraction removed or, alternatively, brans. Of course, the R-T-E cereal art is well developed and the skilled artisan will have no difficulty selecting suitable farinaceous materials for use herein.

The dry ingredients can also include various minor ingredients (not shown) or additives such as sugar(s), soy protein, salt fiber, flavors, vitamins and mineral salts, e.g., trisodium phosphate, and starches which can conveniently be pre-blended with the cereal ingredients 26. In addition to the water 28, various liquid ingredients such as corn (maize) or malt syrups can be added.

In the preferred form, the cereal ingredients include a first principle cereal ingredient. In more preferred variations, the cereal grain ingredient is cut whole grain wheat 26 especially U.S ^{#}2 grade soft white wheat including both Eastern and Western soft white wheats, which have been suitably and adequately cleaned. While white wheat is preferred, red wheat can also be used in full or partial substitution especially soft red wheat.

In other variations, all or a portion of the whole grain cut wheat particles can be substituted with similarly sized particles of other whole grain particles supplied by any of the major cereal grains including, corn (maize), oats, barley, rye, wheat, rice, and mixtures thereof. The grain materials can also be supplied in whole or in part by such minor or “heritage” grains such as spelt, kamut, quinoa and mixtures thereof. While not produced in large quantities, such heritage grains are especially popular among those interested in organic foods. In less preferred variations, the cut grain pieces can be substituted with equivalent amounts or levels of other finer sized cereal ingredients such as cereal flours.

The cooked cereal material 38 additionally comprises about 10-55% moisture. The amount of moisture depends, in part, upon the particular cereal ingredients, desired finished products, cooking equipment and techniques employed. The moisture includes the water contribution from the cereal ingredients themselves (which often are controlled to about 12-15% moisture); the moisture added with any syrup component as well as the moisture added through steam or water per se addition. In a preferred embodiment, the moisture content of the cooked cereal mass ranges from about 20-30%, preferably about 22-28% before exiting the cooker.

If desired, the present cereal dough composition can additionally comprise about 0.1-20% (dry weight) by weight sugar(s) or, synonymously herein, nutritive carbohydrate sweetening agents, preferably about 5-10%. Such materials are also well known in the R-T-E cereal art. Useful herein as the sugar component is sucrose. However, the sugar(s) component can additionally comprise conventional fructose, maltose, dextrose, honey, fruit juice solids, brown sugar, and the like. In addition to providing desirable sweetness, the sugar component additionally beneficially affects the cereal color and texture. Better results are obtained, especially for R-T-E cereal products, when the sugar(s) component comprises from about 1% to about 10% by weight of the composition. In still other variations, inulin can be added to the cooked cereal dough 38 (See, for example, U.S. Pat. No. 6,149,965 “Cereal Products with Inulin and Methods of Preparation” issued Nov. 21, 2000 to van Lengerich, et al.) for fiber fortification.

The starchy cereal component(s) can comprise from about 40 to 99% (dry basis) of the cooked cereal dough composition. Better results in terms of organoleptic attributes and reductions in R-T-E cereal piece frangibility are obtained when the cereal ingredient(s) comprises about 75 to 95% of the cooked cereal dough composition. For best results the cereal ingredients comprise about 80 to 95% of the present cereal products.

If desired, the present cereal dough composition can additionally include a variety of materials designed to improve the aesthetic, organoleptic or nutritional qualities of the cereal. These adjuvant materials can include vitamin and/or mineral fortification, colors, flavors, high potency sweetener(s), and mixtures thereof. The cereal dough can also include a fat or oil ingredient and emulsifiers. The precise ingredient concentration in the present cereal composition will vary in known manner. Generally, however, such materials can each comprise about 0.01% to about 2% dry weight of the cereal composition.

One especially useful material is common salt. Desirably, the salt comprises about 0.1-2%, preferably about 0.5-1.0% of the cereal composition.

Still another highly preferred ingredient is a malt syrup flavor ingredient. The malt syrup comprises about 1-8% (dry basis), preferably about 2-5%.

Nutritional fortification is desirable for many food products especially those for children. Accordingly, in highly preferred embodiments, in particular, the present R-T-E cereals can be fortified with bioavailable sources of calcium, iron, riboflavin and the like. These mineral fortifiers can be incorporated into the cereal compositions directly. It is also desirable to vitamin fortify the present R-T-E cereals, especially selected B vitamins, e.g., riboflavin. Conventional methods and techniques of vitamin fortification can be used herein. Due in part to their heat sensitivity, vitamin fortification is typically practiced by topical application to the R-T-E cereal and such a technique is preferred herein.

In highly preferred embodiments, in particular, the present R-T-E cereals can be fortified with sources of calcium, e.g., to provide up to about 1300 mg elemental calcium per oz. (i.e., up to about 0.5 weight %); (see for example, U.S. Pat. No. 6,913,775 “Cooked Cereal Dough Products Fortified With Calcium And Method Of Preparation” issued Jul. 5, 2005 to Darryl J. Ballman, et al.), iron, riboflavin and the like. These mineral fortifiers can be incorporated into the cereal compositions directly. It is also desirable to vitamin fortify the present R-T-E cereals, especially selected B vitamins, e.g., riboflavin. Conventional methods and techniques of vitamin fortification can be used herein. Due in part to their heat sensitivity, vitamin fortification is typically practiced by topical application to the R-T-E cereal and such a technique is preferred herein.

Step 22 further can comprise the sub-step of sheeting the cooked cereal dough 38 to form a continuous cooked cereal dough sheet 42 (e.g., 25 to 800 microns in thickness). Conventional techniques and equipment can be employed to practice this step such as a pair of counter-rotating rolls depicted and the skilled artisan will have no difficulty in selecting those suitable for use herein.

The present methods 20 can include the step 52 of applying a topical image to at least one face of the sheet 42 to form an image bearing cooked dough sheet 54. The image can be a single image or, in one preferred embodiment, can be in the form of an arranged spaced (i.e., to have spaced lanes free of the image to isolate the image copies) array of multiple identical images such as the giraffe image array 48 depicted. In one preferred form, the image is provided from a supply of one or more edible ink 50 and applied by a printing roll (See, for example, U.S. Pat. No. 6,153,233 “Food Item and Its Fabricating Methods” issued Nov. 28, 2000 to Gordon et al.). In the preferred form, the topical image is applied by an ink jet printer for edible ink images (as described in detail in, for example, U.S. Ser. No. 60/804,965 “Food Product With Edible Images And Apparatus For And Methods Of Preparation” filed Jun. 16, 2006; attorney docket GMI 6646). In minor variations, the topical application of an image can also include a flavor as a separate topical application or flavor. Image ink could also be flavored. Multiple colored inks using two or more rollers can also be applied to create more complex images. In preferred form, the inks are edible inks comprising FD&C colors (e.g., 1-10% colorant in an aqueous carrier)

Methods 20 can include the step 59 of forming the image bearing cooked dough sheet 54 into individual shaped and sized pieces 60. In one variation, forming step can include a first sub-step of cutting sheet 54 into two or more (e.g., a multiplicity) of continuous ribbons 56 such as by using a circular knife cutter 58, a water knife or other suitable means. The forming step 59 can also include a sub-step of cutting the continuous ribbons to form the pieces such as using a cutter roll, a reciprocating guillotine cutter, or other means. In still another variation, the sheets 54 of dough and the individual pieces are formed in a single operation by cutting the sheet into individual pieces or by stamping out planar shaped pieces from the dough sheet 54 especially in squares. The piece forming step 59 can also be practiced to provided additional shape features such as providing surface corrugations for added texture or strength or embossing to provide ornamentation (not shown) such as by including corrugations in the cutting rollers. In still other variations, other features, e.g., embossing can be practiced to provide desirable supplemental features. As noted above, pieces 60 are wet and generally have a moisture content ranging from about 15-35%. The present methods 20 of preparation can further include a sub-step of partially drying 62 the shaped and sized individual wet pieces 60 to form dried pellets 64 such as in a pellet dryer which removes a portion of the moisture.

The present methods 20 of preparation can further include a step or sub-step of finish drying 70 the dried pellets 64 to form dried base pieces 72 such as in a pellet dryer which removes an additional portion of the moisture.

The skilled artisan will appreciate that the particular practice or technique used to practice the finish drying step 70 depends in important part upon the desired end product. For example, when the desired end product is an R-T-E cereal, then the finish drying step can be practiced wherein the pieces are dried to final dried moisture contents of 1-5%. Useful to practice such a finish drying step is a fluidized bed dryer that can not only dry but also toast and puff the pieces. Such equipment can have from one to even four separate heating zones including the two zones depicted for toasting and puffing in FIG. 3. In the preparation of snacks, the finish drying can be practiced, for example, in a deep fat fryer, or, for low fat products, in an oven.

If desired, the present cereal products 72 can be fabricated into presweetened R-T-E cereals such as by the topical application of a conventional sweetener coating. Thus, the present invention can include the step of applying 80 a pre-sweetener coating to the dried pieces 72. Both conventional sugar coatings and coatings employing high potency sweeteners, especially aspartame and potassium acesulfame, are known and can be used to provide presweetened cereals for use herein.

Referring once again to the schematic flow diagram of FIG. 3, the cereal pieces 72 can optionally be provided with a topical coating such as a pre-sweetener or sugar coating. In one variation, typically referred to as a wet sugar coating process, the process can include the step 80 of applying a concentrated hot liquid sugar syrup 86 to the dried cereal pieces 72 to form sugar coated or enrobed pieces 89. The sugar syrup is heated in heat exchanger. In commercial practice a quantity of dried pieces 72 or base in charged to an enrober along with a quantity of the sweetener syrup 86.

In certain variations of this embodiment, a portion or preferably all of the sugar is replaced with an equivalent level of low conversion maltose (see, for example U.S. Ser. No. 60/565,473 “Low Sugar Presweetened Coated Cereals and Method of Preparation” filed Apr. 26, 2004) or other nutritive carbohydrate sweetening ingredients.

In still other variations, all or a portion of the sugar(s) or nutritive carbohydrate sweetening ingredients can be replaced with non nutritive sweeteners such non-nutritive sweeteners: aspartame, saccharin, acesulfame K, sucralose, neotame, and mixtures thereof. Preferred for use herein for a non nutritive sweetener is sucralose. From time to time, new high potency or non-nutritive sweeteners are developed and permitted by food regulation and the use of such to-be-developed sweeteners is contemplated herein.

In other variations, the topical coating can include a soluble fiber component especially inulin. An advantage to use of inulin is that inulin mimics the physical properties of sugars in cereal coatings and thus is easy to apply to finished cereal products. (See, for example, U.S. Pat. No. 6,149,965 “Cereal Products with Inulin and Methods of Preparation” issued Nov. 21, 2000 to Larson). Also, due to the clarity of the topical coating so formed, the inulin will surprisingly not interfere with the provision of the visual image.

In other variations, an insoluble fiber ingredient, e.g., wheat, corn and/or rice bran), can be topically applied to increase the fiber content of the finished products. If used, inulin can be present from about 1-15% of the cooked cereal dough. Also, as described in the '965 patent, additional inulin can be topically applied (such as to increase the fiber content of the finished products) in addition of in substitution for inulin present in the cooked cereal dough composition.

In other variations, the topical coating can include a flavor whether liquid (e.g., a citrus flavor) or a solid (e.g., cinnamon). Also, vitamin and mineral fortification can be added to the topical coating.

In other variations, an oil topical coating optionally with salt and/or flavors is applied to form finished dried snack products. In certain variations, the oil can be the high oryzanol rice bran oil such as described in co-pending U.S. Ser. No. 11/347,134 “Food Products Containing Rice Bran Oil” filed Feb. 3, 2006 (attorney docket GMI 6561 US). For snack executions, the topical coating can include a seasoning blend such as a cheese and/or savory flavored seasoning.

If employed, the topical sweetening is applied in sufficient amounts such that after drying to remove added moisture associated with the sugar coating solution, the sugar coating is present in a weight ratio of sugar coating to cereal base of about 1:100 to about 100:100, preferably 5:100 to about 40:100 an more preferably about 20:100. Typically, the sugar coating solution will have a blend of sugars and will comprise about 4-20% moisture.

The present methods can further include a finish drying step to remove the moisture added by or with the sweetener syrup 86 to provide finished dried products having a moisture content of about 1-5% to form presweetened R-T-E finished cereal pieces 12 such as in finish dryer. Dryer can have a first hot drying section heated with forced hot dry air and a second cooling section.

In other variations, an oil topical coating optionally with salt and/or flavors is applied to form finished dried snack products.

In still another variation, the pieces or pellets can be deep fat fried to form dried puffed fried finished cereal products fortified with rice bran oil. Such dried puffed fried finished cereal pieces are especially desirable as fiber fortified snack products. Such products can absorb about 5-35% of frying fat during the drying and puffing step.

The finished dried R-T-E cereal can be packaged and distributed in conventional form.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A food product, comprising:
a quantity of pieces each having at least one major surface and each having at least a portion of an image on the major surface that collectively, can be used to form image puzzles.

2. The food product of claim 1 fabricated from a cooked cereal dough.

3. The food product of claim 2 having a moisture content of about 1-5% and wherein the pieces have a thickness ranging from about 2-4 mm and a bulk density ranging from about 0.1-0.3 g/cc.

4. The food product of claim 3 wherein the image portion is randomly positioned on the major surface and is provided by an edible ink.

5. The food product of claim 4 wherein the image portion includes the form of a line drawing of a character or figurine.

6. The food product of claim 5 wherein the food product is a pre-sweetened R-T-E cereal.

7. The food product of claim 6 wherein the image is applied by ink jet printing of a edible ink.

8. The food product of claim 7 wherein the pieces have a regular geometric peripheral shape.

9. The food product of claim 8 wherein at least a portion of the pieces are planar.

10. A packaged consumer food product article, comprising:
A sealed food packaging container; and
A quantity of pieces each having at least one major surface and each having at least a portion of an image on the major surface that collectively, can be used to form an image puzzle, disposed within the sealed container.

11. The article of claim 11, additionally comprising:
A game kit component selected from the group consisting of a game board, instructions, a bucket; a pail; question tabs; bonus tabs; reference cards; a first set of play pieces; a second set of play pieces; a collection of first award tokens; a collection of second award tokens; and mixtures thereof.

12. A method for preparing a food product having enhanced play value, comprising the steps of:
Providing cooked cereal dough in the form of a continuous sheet having a major surface;
Forming the sheet into individual pieces at least some of which have at least a image fragment; and,
Forming the pieces into a quantity of finished food products pieces each having at least one major surface and each having at least a portion of an image on the major surface that collectively can be used to at least partially reassemble the image thereby forming image puzzles.

13. The method of claim 12 wherein fabricated from a cooked cereal dough.

14. The method of claim 13 wherein having a moisture content of about 1-5% and wherein the pieces have a thickness ranging from about 2-4 mm and a bulk density ranging from about 0.1-0.3 g/cc.

15. The method of claim 14 wherein the image portion is randomly positioned on the major surface and is provided by an edible ink.

16. The method of claim 15 wherein the image portion includes the form of a line drawing of a character or figurine.

17. The method of claim 15 wherein the food product is a pre-sweetened R-T-E cereal.

18. The method of claim 15 wherein the image is applied by ink jet printing of a edible ink.

19. The method of claim 15 wherein the pieces have a regular geometric peripheral shape.

20. The method of claim 15 wherein at least a portion of the pieces are planar.
